(19) United States
(12) Patent Application Publication
(10) Pub. No.: US 2022/0039356 A1
(43) Pub. Date: Feb. 10, 2022

(54) PROTECTIVE APPARATUS FOR A MALE ANIMAL

(71) Applicant: Shona M. Conley, Moose Jaw (CA)

(72) Inventor: Shona M. Conley, Moose Jaw (CA)

(21) Appl. No.: 17/397,576

(22) Filed: Aug. 9, 2021

Related U.S. Application Data
(60) Provisional application No. 63/063,484, filed on Aug. 10, 2020.

(51) Int. Cl. A01K 27/00; A01K 13/00

(52) U.S. Cl. CPC A01K 27/002; A01K 13/006

(57) ABSTRACT

A protective apparatus covers the male genitalia of an animal, for example a dog. The apparatus includes a harness arrangement securable about a torso of the animal and a cage supported by the harness arrangement to at least partially surround the male genitalia of the animal when the harness arrangement is worn about the torso of the animal. The cage is resilient and self-supporting in shape, while including one or more openings therein sized to allow passage of bodily fluids therethrough. The apparatus prevents copulation and/or prevents animal access to wounds resulting from neutering of the animal. The self-supporting material of the cage ensures that the cage is supported in spaced apart relation with the male genitalia so that urine is less likely to be directed onto the belly of the animal during urination, while still remaining comfortable for the animal due to its resilient collapsibility.

This application claims the benefit under 35 U.S.C. 119(e) of U.S. provisional application Ser. No. 63/063,484, filed Aug. 10, 2020.

### FIELD OF THE INVENTION

The present invention relates to a protective apparatus for a male animal, and more particularly the present invention relates to a protective device for covering male genitalia of a dog to (i) prevent copulation of the dog with other dogs when used for anti-breeding, or (ii) prevent access to wounds, for example following neutering of the dog.

### BACKGROUND

Various device exist for the purposes of preventing female animals such as dogs from being impregnated by providing some form of apparatus that can be worn by the animal and that includes a pad or shield that covers the female genitalia of the animal.

One example of a device to prevent breeding of either a female or a male dog is described in U.S. Pat. No. 7,044,087 by Jomain Brecheen. In this instance, a protective garment has a first forward harness portion and a rear genitalia protection portion. The rear portion includes a woven vinyl mesh material covering both the male genitalia and the female genitalia which allows fluid flow such as urine therethrough. The portion that covers the male genitalia does not allow a male dog to copulate, but the mesh material is intended to be worn directly against the abdomen in a manner that causes urine to soak the belly of the dog in the instance of male dogs in particular.

Alternatively, when a male dog is neutered, it is common for a resulting wound and stitches to be present at the site of the male genitalia following the neutering procedure. To prevent the dog from licking the wound in a manner that interferes with proper healing it is common practice to use a cone worn about the head of the animal; however, such cones can result in difficulty eating as well as cause general stress to the animal.

### SUMMARY OF THE INVENTION

According to one aspect of the invention there is provided a protective apparatus for an animal having male genitalia, the apparatus comprising:

a harness arrangement securable about a torso of the animal; and

a cage coupled to the harness arrangement;

the cage being arranged to at least partially surround the male genitalia of the animal when the harness arrangement is worn about the torso of the animal;

the cage including one or more openings therein sized to allow passage of bodily fluids therethrough;

the cage being formed of a resilient material (i) that is self-supporting so as to be arranged to retain a shape of the cage and (ii) that is resiliently deformable when compressed.

The self-supporting and resilient material of the cage allows the cage to be supported in spaced apart relation with the male genitalia so that urine is less likely to be directed onto the belly of the animal during urination by the animal, while still remaining comfortable for the animal due to its collapsibility.

When used for anti-breeding, the cage is preferably arranged to sufficiently surround the male genitalia so as to prevent copulation of the animal with another animal.

When used following neutering of the animal, the cage is preferably arranged to surround at least a scrotal area of the male genitalia.

The cage may be formed of mesh material defining an array of openings therein.

Preferably the one or more openings occupy a greater surface area of the cage than the resilient material of the cage between the one or more openings.

The cage may be elongated in a longitudinal direction between opposing front and rear ends of the cage, and preferably includes (i) two opposing side edges extending in the longitudinal direction so as to be arranged for abutment against an abdomen of the animal and (ii) a bottom wall extending laterally between the two opposing side edges, in which the bottom wall includes a central portion between the two opposing side edges that is spaced below opposing side edges.

An inner side of the bottom wall is preferably generally concave between the opposing side edges such that the shape of the cage forms part of a cylinder.

The cage preferably further includes an end wall connected to the bottom wall at the front end of the cage so as to enclose the front end of the cage.

The harness arrangement preferably includes: (i) a hip strap connected at laterally opposing sides of the cage so as to be arranged to be received about the torso of the animal in proximity to hips of the animal, (ii) a belly strap connected to the cage forwardly of a front end of the cage so as to be arranged to be received about a torso of the animal at a location spaced forwardly of hips of the animal, (iii) a neck strap forming a loop connected to a front end of the cage, the neck strap being arranged to be secured across a chest area and about a neck of the animal, or (iv) any combination of a hip strap, a belly strap, and/or a neck strap.

Preferably, the neck strap is elastically stretchable in length.

According to a second aspect of the present invention, there is provided a protective apparatus for an animal having male genitalia, the apparatus comprising:

a harness arrangement securable about a torso of the animal; and

a cage coupled to the harness arrangement;

the cage being arranged to at least partially surround the male genitalia of the animal when the harness arrangement is worn about the torso of the animal;

the cage being elongated in a longitudinal direction between opposing front and rear ends of the cage, the cage including (i) two opposing side edges extending in the longitudinal direction so as to be arranged for abutment against an abdomen of the animal, (ii) a bottom wall extending laterally between the two opposing side edges, the bottom wall including a central portion between the two opposing side edges that is spaced below opposing side edges in which the bottom wall has an inner side that is generally concave between the opposing side edges such that the shape of the cage forms part of a cylinder, and (iii) an end wall connected to the bottom wall at the front end of the cage so as to enclose the front end of the cage;

the cage including one or more openings formed therein and sized to allow passage of bodily fluids therethrough;

the cage being formed of a resilient material (i) that is self-supporting so as to be arranged to retain a shape of the cage and (ii) that is resiliently deformable when compressed;

the harness arrangement including (i) a hip strap connected at laterally opposing sides of the cage so as to be arranged to be received about the torso of the animal in proximity to hips of the animal, (ii) a belly strap connected to the cage forwardly of a front end of the cage so as to be arranged to be received about a torso of the animal at a location spaced forwardly of hips of the animal, and (iii) a neck strap forming a loop connected to a front end of the cage, the neck strap being arranged to be secured about a neck and across a chest area of the animal.

### BRIEF DESCRIPTION OF THE DRAWINGS

One embodiment of the invention will now be described in conjunction with the accompanying drawings in which:

FIG. 1 is a perspective view of a protective apparatus according to the present invention;

FIG. 2 is a rear bottom view of the protective apparatus;

FIG. 3 is a side view of the protective apparatus;

FIG. 4 is a perspective view of a bottom side of the cage of the protective apparatus;

FIG. 5 is a bottom view of the front end of the cage of the protective apparatus illustrating connection of the neck strap and the belly strap at the front end of the cage;

FIG. 6 is a top view of the cage of the protective apparatus illustrating connection of the neck strap and the belly strap at the front end of the cage and connection of the hip strap at opposing sides of the cage; and

FIG. 7 is a schematic representation of the protective device supported on an animal.

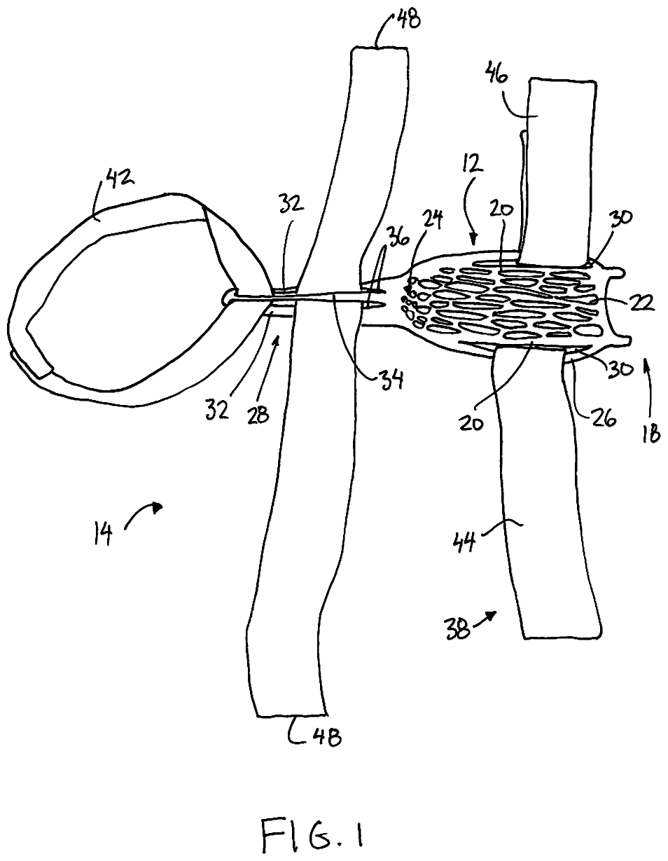

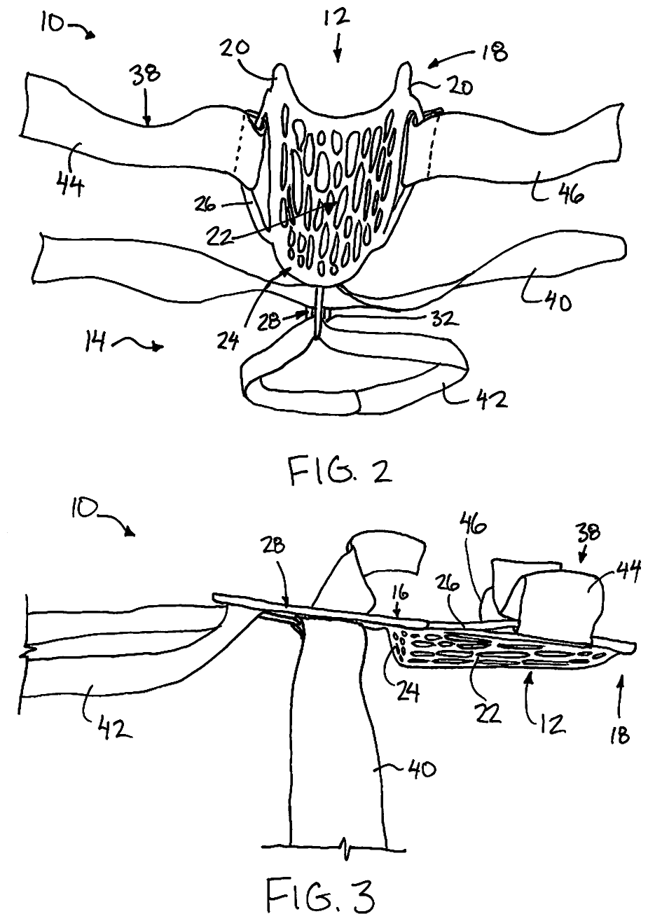

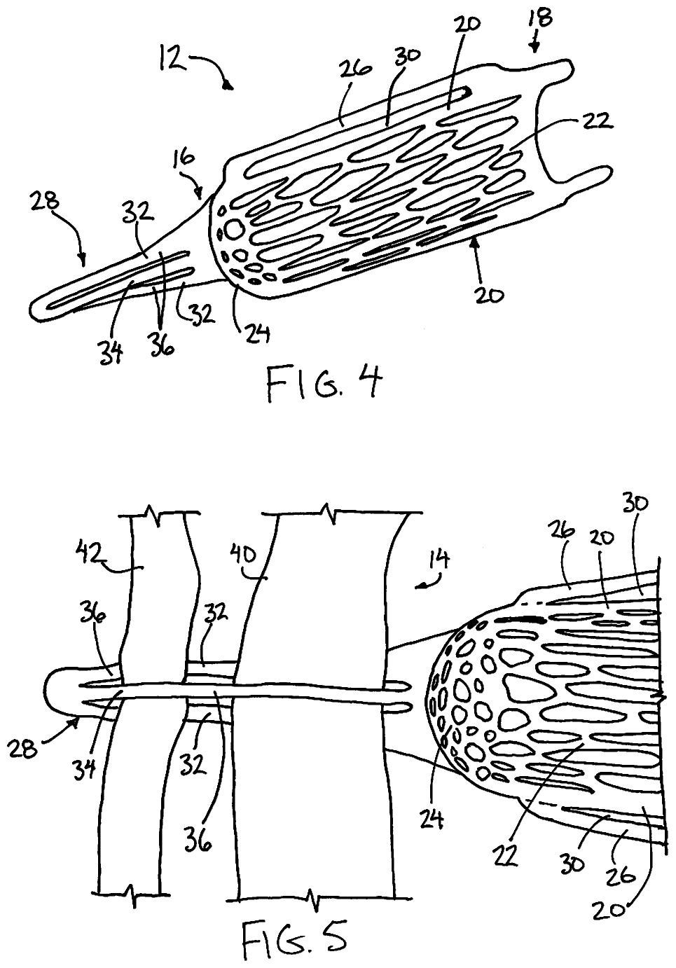

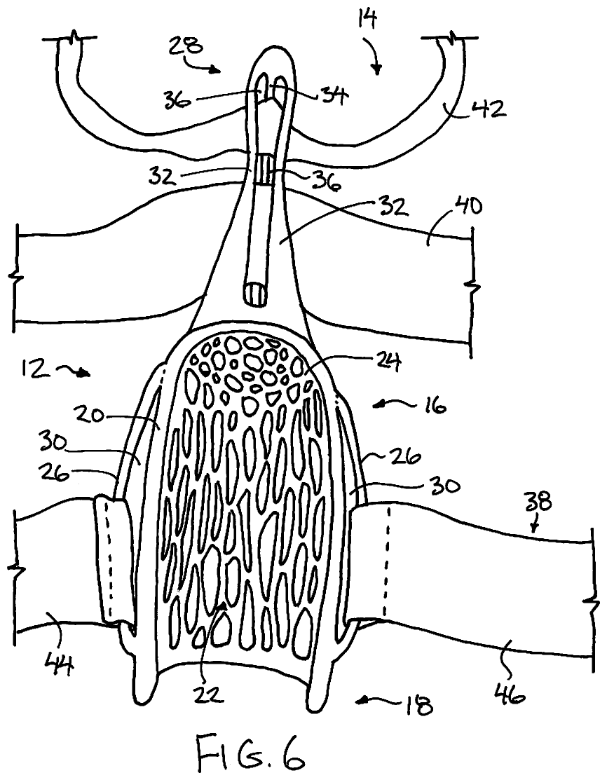

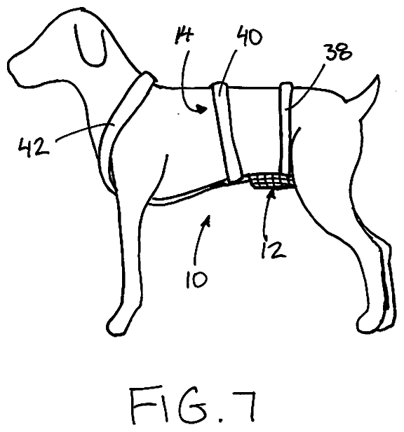

In the drawings like characters of reference indicate corresponding parts in the different figures.

### DETAILED DESCRIPTION

Referring to the accompanying figures there is illustrated an animal protective apparatus generally indicated by reference numeral 10. The apparatus 10 is particularly suited for use in covering the male genitalia of a dog to (i) prevent the dog from copulating with other dogs, and/or (ii) prevent the dog from accessing wounds in the genital area, for example following neutering.

The apparatus 10 generally includes (i) a cage 12 formed of a resilient material for surrounding the male genitalia of the dog and (ii) a harness arrangement 14 securable about a torso of the dog for holding the cage in place such that it prevents copulation of the dog with other dogs. The cage is formed of a suitable resilient material that is both self-supporting so as to be capable of retaining its shape when no external forces are applied to the cage and resiliently deformable so as to be readily collapsible when compressed for example under the weight of a dog lying down.

The cage 12 is elongate in a longitudinal direction between a front end 16 and a rear end 18 at longitudinally opposed ends thereof. The cage further includes two side edges 20 which are spaced apart at laterally opposing sides of the cage and which extend in the longitudinal direction at spaced apart locations at the top side of the cage. The side edges of the cage are arranged for abutment against the abdomen of the dog on either side of the male genitalia.

The cage 12 further includes a bottom wall 22 extending substantially the full length of the cage and spanning substantially the full width of the cage between the opposing side edges 20. The bottom wall is generally curved about a longitudinal axis of the cage so as to be concave at the inner side of the cage and so as to be lower at a central portion of the bottom wall than at either of the opposing side edges 20. The bottom wall thus forms part of the surface of a cylinder in shape so as to form a trough which is generally open at the rear end of the bottom wall and open at the top side between the side edges 20 of the cage.

The cage 12 further includes an end wall 24 lying transversely to the longitudinal axis of the cage at the front end for enclosing the front end of the bottom wall 22.

The bottom wall 22 and the end wall 24 define a boundary of an internal space at the inner side of the cage which is suitably sized to receive the male genitalia of the dog therein while remaining spaced apart from the genitalia so as to allow the genitalia to hang freely so as not to interfere with urination by the dog.

Both the bottom wall 22 and the end wall 24 are formed of a suitable mesh structure defining an array of mesh openings therein which are spaced apart laterally and longitudinally from one another. The mesh openings are sized so as to occupy a greater surface area of the overall cage than the material forming the cage between the mesh openings. The mesh openings are further suitably sized to readily allow the passage of urine therethrough.

A mounting arrangement is provided on the cage for coupling the harness 14 to the cage. The mounting arrangement generally includes two side bars 26 at laterally opposing sides of the cage and an extension body 28 extending forwardly from the front end of the cage. The side bars 26 are provided at laterally opposing sides of the cage to extend alongside respective ones of the side edges 20 in spaced apart relation thereto while being joined at opposing front and rear ends thereof to the side edges of the cage. In this manner, a side slot 30 is formed at each side of the cage between a respective side edge 20 of the cage and a respective one of the side bars 26.

The extension body 28 protrudes forwardly from the front end of the cage by a length in the longitudinal direction which is near a length of the cage. The extension body 28 generally includes two side members 32 extending in the longitudinal direction and one intermediate member 34 also extending in the longitudinal direction at a laterally central location between the side members in spaced apart relation therewith. The side members 32 and the intermediate member 34 are joined together at opposing forward and rearward ends so as to define a pair of forward slots 36 in the extension body 28. The forward slots 36 are each defined between the intermediate member 34 and a respective one of the side members 32 so that the forward slots are parallel to one another and elongated in the longitudinal direction while extending forwardly from the front end of the cage.

The bottom wall 22, the end wall 24, the side bars 26, and the intermediate member 34 and side members 32 of the extension body 28 are all formed together as a single, unitary body in which the components are seamlessly joined with one another of a common material throughout as a single formed or molded structure. The single structure is typically formed of a resilient plastic material that retains its shape when no external force is applied but can be collapsed easily when compressed. All of the edges of the structure are smooth and rounded for fitting comfortably against the dog. A top surface of the extension body 28 and the side edges 20 at the top side of the cage lie in a generally common flat plane with one another to comfortably lie flat against the abdomen of the dog in a mounted position.

The harness 14 includes (i) a hip strap 38 joined at laterally opposing sides of the cage for extending about the torso of the dog adjacent to the hips, (ii) a belly strap 40 extending about the torso of the dog at a location forwardly of the male genitalia, and (iii) a neck strap 42 arranged to extend around the back of the neck of the dog while being connected to the cage across the chest of the dog.

The hip strap 38 includes a first portion 44 and a second portion 46 mounted onto the side bars 26 at opposing sides of the cage respectively. Each portion 44 and 46 of the hip strap includes an inner end secured by stitching into a loop extending about the respective side bar such that the hip strap is threaded through the corresponding side slot 30 at the side of the cage. The opposing outer end of each portion 44 and 46 of the hip strap includes releasable fasteners mounted thereon. For example the fasteners on the first portion 44 may comprise hooks while the fasteners on the second portion may comprise loops, in which the hooks and loops are arranged to be releasably fastened to one another for selectively and adjustably securing the hip strap about the torso of the dog.

The belly strap 40 comprises a continuous strap which is threaded through both forward slots 36 of the extension body 28 between two opposing ends 48 of the belly strap. The opposing ends 48 of the belly strap also include releasable fasteners mounted thereon. For example, the fasteners on one end of the belly strap may comprise hooks while the fasteners on the other end may comprise loops, in which the hooks and loops are arranged to be releasably fastened to one another for selectively and adjustably securing the belly strap about the torso of the dog at a location spaced forwardly of the hip strap and forwardly of the male genitalia of the dog.

The neck strap may be formed as a continuous loop which is also threaded through both forward slots 36 of the extension body 28 so as to couple the neck strap to the forward end of the cage. The neck strap may be formed of an elastic material that is elastically stretchable in length such that the neck strap is typically supported under tension in a mounted position on the dog. The neck strap is intended to extend around the back of the neck and across both shoulders of the dog to be connected to the cage across the chest of the dog.

In order to mount the apparatus 10 onto a dog, the head of the dog is initially inserted through the neck strap followed by positioning of the cage surrounding and covering the male genitalia of the dog. The belly and hip straps can then be fastened into loops at respective locations about the torso of the dog.

The apparatus 10 can be made available in multiple different sizes for accommodating different sizes of dogs. In each instance the appropriately sized apparatus 10 is selected for the dog such that the cage is sized to fully receive the male genitalia of the dog therein including the prepuce and the testicles in a substantially non-contacting manner to allow the male genitalia to hang freely for normal urination by the dog so that urine is directed away from the abdomen. The mesh openings are sized to readily allow the urine to pass freely therethrough while preventing copulation of the dog with other dogs.

Since various modifications can be made in my invention as herein above described, and many apparently widely different embodiments of same made, it is intended that all matter contained in the accompanying specification shall be interpreted as illustrative only and not in a limiting sense.

1. A protective apparatus for an animal having male genitalia, the apparatus comprising:
a harness arrangement securable about a torso of the animal; and
a cage coupled to the harness arrangement;
the cage being arranged to at least partially surround the male genitalia of the animal when the harness arrangement is worn about the torso of the animal;
the cage including one or more openings therein sized to allow passage of bodily fluids therethrough;
the cage being formed of a resilient material (i) that is self-supporting so as to be arranged to retain a shape of the cage and (ii) that is resiliently deformable when compressed.

2. The apparatus according to claim 1 wherein the cage is formed of mesh material defining an array of openings therein.

3. The apparatus according to claim 1 wherein the one or more openings occupy a greater surface area of the cage than the resilient material of the cage between the one or more openings.

4. The apparatus according to claim 1 wherein the cage is elongated in a longitudinal direction between opposing front and rear ends of the cage, the cage including (i) two opposing side edges extending in the longitudinal direction so as to be arranged for abutment against an abdomen of the animal and (ii) a bottom wall extending laterally between the two opposing side edges, the bottom wall including a central portion between the two opposing side edges that is spaced below opposing side edges.

5. The apparatus according to claim 4 wherein an inner side of the bottom wall is generally concave between the opposing side edges such that the shape of the cage forms part of a cylinder.

6. The apparatus according to claim 4 wherein the cage further includes an end wall connected to the bottom wall at the front end of the cage so as to enclose the front end of the cage.

7. The apparatus according to claim 1 wherein the harness arrangement includes a hip strap connected at laterally opposing sides of the cage so as to be arranged to be received about the torso of the animal in proximity to hips of the animal.

8. The apparatus according to claim 1 wherein the harness arrangement includes a belly strap connected to the cage forwardly of a front end of the cage so as to be arranged to be received about a torso of the animal at a location spaced forwardly of hips of the animal.

9. The apparatus according to claim 1 wherein the harness arrangement includes a neck strap forming a loop connected to a front end of the cage, the neck strap being arranged to be secured across a chest area and about a neck of the animal.

10. The apparatus according to claim 9 wherein the neck strap is elastically stretchable in length.

11. The apparatus according to claim 1 wherein the cage is arranged to surround the male genitalia in a manner that prevents copulation of the animal with another animal.

12. The apparatus according to claim 1 wherein the cage is arranged to surround a scrotal area of the male genitalia.

13. A protective apparatus for an animal having male genitalia, the apparatus comprising:
a harness arrangement securable about a torso of the animal; and
a cage coupled to the harness arrangement;
the cage being arranged to at least partially surround the male genitalia of the animal when the harness arrangement is worn about the torso of the animal;
the cage being elongated in a longitudinal direction between opposing front and rear ends of the cage, the cage including (i) two opposing side edges extending in the longitudinal direction so as to be arranged for abutment against an abdomen of the animal, (ii) a bottom wall extending laterally between the two opposing side edges, the bottom wall including a central portion between the two opposing side edges that is spaced below opposing side edges in which the bottom wall has an inner side that is generally concave between the opposing side edges such that the shape of the cage forms part of a cylinder, and (iii) an end wall connected to the bottom wall at the front end of the cage so as to enclose the front end of the cage;
the cage including one or more openings formed therein and sized to allow passage of bodily fluids therethrough;
the cage being formed of a resilient material (i) that is self-supporting so as to be arranged to retain a shape of the cage and (ii) that is resiliently deformable when compressed;
the harness arrangement including (i) a hip strap connected at laterally opposing sides of the cage so as to be arranged to be received about the torso of the animal in proximity to hips of the animal, (ii) a belly strap connected to the cage forwardly of a front end of the cage so as to be arranged to be received about a torso of the animal at a location spaced forwardly of hips of the animal, and (iii) a neck strap forming a loop connected to a front end of the cage, the neck strap being arranged to be secured about a neck and across a chest area of the animal.
